(19) United States
(12) Patent Application Publication
(10) Pub. No.: US 2026/0368492 A1
(43) Pub. Date: Nov. 19, 2026

(54) SYSTEMS AND METHODS FOR CONVERSON BETWEEN DIGITAL AND ANALOG FOR PHOTONIC NEURAL NETWORKS

(71) Applicant: Taiwan Semiconductor Manufacturing Company, Ltd., Hsinchu (TW)

(72) Inventors: You-Cheng Lu, Tainan City (TW); Stefan Rusu, Sunnyvale, CA (US); Lan-Chou Cho, Hsinchu City (TW); Ming Yang Jung, Kaohsiung City (TW); Tai-Chun Huang, New Taipei City (TW)

(21) Appl. No.: 19/742,294

(22) Filed: Jul. 15, 2026

Related U.S. Application Data
(63) Continuation of application No. 19/059,556, filed on Feb. 21, 2025.
(60) Provisional application No. 63/698,599, filed on Sep. 25, 2024.

(51) Int. Cl. G06N 3/0464; G02F 1/21; G02F 1/225

(52) U.S. Cl. CPC G06N 3/0464; G02F 1/212; G02F 1/225

(57) ABSTRACT

An electronic-photonic integrated circuit device for a convolutional neural network performs aspects of analog-to-digital conversion (ADC) or digital-to-analog conversion (DAC) in the photonic integrated circuit. The DAC may be performed using optical modulators. Each optical modulator receives a plurality of electrical input signals collectively representing an input value or kernel weight. The electrical input signals are applied to distinct modulator segments. The modulator segments combine to encode the digital data into a corresponding analog optical signal. The ADC may include splitting the optical output signals and providing distinct degrees of attenuation to each of the signal splits. The signals splits with various attenuation levels are converted into electrical output signals that are compared to a reference voltage to determine a digital encoding. The attenuation levels may be selected so that one reference voltage may be used for all the comparisons.

### REFERENCE TO RELATED APPLICATIONS

This Application is a Continuation of U.S. application Ser. No. 19/059,556, filed on Feb. 21, 2025, which claims the benefit of U.S. Provisional Application No. 63/698,599, filed on Sep. 25, 2024. The contents of the above-referenced Patent Applications are hereby incorporated by reference in their entirety.

### BACKGROUND

Artificial intelligence/machine learning (AI/ML) algorithms have traditionally been implemented by electrical computing, which has seen rapid increases in computational speed and capability in accordance with Moore's law. However, AI/ML algorithms have computational demands that are outpacing Moore's law. Further, even if Moore's law were to keep up, the projected power consumption would not be sustainable since improvements in power efficiency do not come at the same rate as improvements in computational speed. Therefore, optical computing is receiving increasing attention due to its ability to achieve higher computational speed with lower power consumption.

### BRIEF DESCRIPTION OF THE DRAWINGS

Aspects of the present disclosure are best understood from the following detailed description when read with the accompanying figures. In accordance with standard industry practice, features are not drawn to scale. Moreover, the dimensions of various features within individual drawings may be arbitrarily increased or reduced relative to one another to facilitate illustration or provide emphasis.

FIGS. 1-3 provide schematic illustrations of electronic-photonic integrated circuit (EPIC) devices embodying multiple aspects of the present disclosure.

FIGS. 4-15 illustrates electro-optic transducers in accordance with various embodiments.

FIG. 16 provides a schematic illustration of an EPIC device according to an embodiment of the present disclosure.

FIG. 17 provides a table illustrating analog-to-digital conversion (ADC) in accordance with an embodiment.

FIGS. 18-25 illustrate optical attenuation systems in accordance with various embodiments.

FIGS. 26-27 provide schematic illustrations of EPIC devices configured for feedback control over attenuation levels in accordance with various embodiments of the present disclosure.

FIG. 28-29 provide flow charts for convolutional neural networks employing various aspects of the present disclosure.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact.

Spatially relative terms, such as “beneath,” “below,” “lower,” “above,” “upper”, and the like, may be used herein to describe one element or feature's relationship to another element(s) or feature(s) as illustrated in the figures. These spatially relative terms are intended to encompass different orientations of the device or apparatus in use or operation in addition to the orientation depicted in the figures. The device or apparatus may be otherwise oriented (rotated 90 degrees or at other orientations) and the spatially relative descriptors used herein may be interpreted accordingly. Terms “first”, “second”, “third”, “fourth”, and the like are merely generic identifiers and, as such, may be interchanged in various embodiments. For example, while an element (e.g., an opening) may be referred to as a “first” element in some embodiments, the element may be referred to as a “second” element in other embodiments.

Deep learning with a convolutional neural network (CNN) can be efficiently performed with an electronic-photonic integrated circuit (EPIC) device. The EPIC include both a photonic integrated circuit (PIC) and an electrical integrated circuit (EIC). The most computationally intensive part of the CNN is the multiply-and-accumulate (MAC) operations that make up the convolutions. An MAC operation is multiplication of an input data vector of size K with a matrix (kernel) of size K×N to produce an output data vector of size N. Specifically, each of the K input data values is multiplied by N corresponding kernel weights in a row of the matrix, resulting in K×N multiplications in total. The products are summed (accumulated) by column of the matrix to generate the output data vector. The PIC efficiently performs MAC operations by applying cascaded photonic processes to analog optical signals encoding the input data and the kernel weights.

Certain other operations of the CNN are more efficiently performed by the EIC. These operations may include, for example, kernel weight initialization and updates, memory management and storage, pooling operations, conditional logic, error correction, and non-linear activation functions. Such operations are executed digitally on the EIC. Digital-to-analog conversion (DAC) is used when transferring data from the EIC to the PIC and analog-to-digital conversion (ADC) is used when transferring data from the PIC to the EIC. Traditionally, DAC and ADC functions have been handled by the EIC.

Field programmable gate arrays (FPGAs) are commonly used in the electrical integrated circuits (EICs) of CNN devices. FPGAs include configurable logic blocks, programmable interconnects, and memory elements, enabling parallel processing within a flexible structure that can be reprogrammed as needed, making them well suited for CNN applications. However, a limitation of FPGAs is the number of ports available for input/output signals, referred to as FPGA control signals. These control signals are used to provide kernel weights and input data for the MACs. As a result, the number of available FPGA control signals limits the bandwidth of CNN computations. Additionally, ancillary functions performed by the EIC that rely on these control signals further reduce the number available for kernel weights and input data, thereby further constraining the bandwidth and overall computational capacity of the CNN.

One aspect of the present disclosure is an EPIC device in which DAC is performed within the PIC. Performing DAC in the PIC frees up FPGA control signals, thereby increasing the overall computational capacity of the system. The optical DAC may be applied to the input data, the kernel weights, or both. The DAC is performed by optical modulators. Each optical modulator receives multiple electrical input signals collectively representing a digital encoding of an input datum or kernel weight and produces a single optical input signal which is an analog representation of that same information.

In some embodiments, the electrical input signals are binary signals having only two possible values. In other embodiments, the electrical input signals are encoded using pulse amplitude modulation 4 (PAM4), where each signal has four possible amplitudes and carries two bits of data. More generally, the electrical input signals may be PAMx-encoded signals where x=2ⁿ and n is an integer greater than or equal to 2. Regardless of how many bits are encoded by each electrical input signal, the corresponding optical input signal encodes a greater number of bits.

In some embodiments, each optical modulator comprises two or more modulator segments, with each segment receiving a distinct electrical input signal. This enables the analog optical signal produced by the modulator to be determined by multiple electrical input signals. The optical signal may use amplitude encoding, phase encoding, or a combination of both. In some embodiments, both amplitude and phase encoding are used simultaneously. Combining amplitude and phase encoding increases the number of distinguishable signal states, providing higher fidelity and enabling the computational core to operate with greater precision.

The two or more modulator segments may be disposed in attenuators, Mach-Zehnder modulator (MZMs), micro-ring modulators (MRMs), the like, or a combination thereof. In some embodiments, two or more modulator segments are disposed in one arm of an MZM. In some embodiments, two or more modulator segments are disposed within a single MRM. These arrangements can provide compact structures with both phase and amplitude modulation. In some embodiments, each optical modulator includes modulator segments distributed among a combination of attenuators, MZMs, MRMs, or similar components, which may provide higher fidelity data encoding by leveraging complementary modulation mechanisms. In various embodiments, the optical modulators (MZMs, MRMs, or the like) are arranged in a series configuration, a parallel configuration, or a mixed parallel and series configuration. The series, parallel, and mixed configurations each have advantages in terms of providing a particular blend of amplitude modulation, phase modulation, or a combination of amplitude and phase modulation.

In some embodiments, each of the two or more modulator segments in one of the optical modulators has a distinct modulation efficiency. The modulators may have distinct lengths that are proportional to the modulation efficiencies. In some embodiments, the modulation efficiencies differ by a factor of two. For example, with three modulator segments, if the smallest has a modulation efficiency E₁, the other two may have modulation efficiencies or 2×E₁ and 4×E₁. Accordingly, if the smallest segment has length L₁, the other two may have lengths 2×L₁ and 4×L₁. In some embodiments, the electrical signals have PAM4 encoding and the modulation efficiencies differ by a factor of four. More generally, the electrical signals may have PAMx encoding and the modulation efficiencies scale by a factor of x (e.g., 8, 16, etc.). Following these relationships enables high efficiency data encoding, with each input signal having an independent effect on the output signal.

In some embodiments, the optical modulator has an MZM structure with corresponding modulator elements on opposite arms. This arrangement helps maintain equal optical path lengths, ensuring stable modulation. In some embodiments, each pair of modulator elements is controlled by a single electrical signal. The two elements in a pair may apply the electrical signal with opposite polarities, enabling push-pull operation, which modulates the amplitude of the optical signal. Push-pull operation also reduces the required driving voltage compared to single-arm operation, where the electrical signal is applied to one modulator element while the other is connected to ground or a reference voltage. In some embodiments, single-arm operation is used for simplified control. Single-arm operation produces a mixture of amplitude and phase modulation. In other embodiments, both modulator elements in a pair apply the electrical signal with the same polarity, enabling push-push operation, which modulates the phase of the optical signal.

Another aspect of the present disclosure is an EPIC device in which a part of the ADC process is performed within the PIC. The part of the ADC process that is performed within the PIC reduces the number of electrical reference signals required and frees up FPGA control signals, thereby increasing the system's computational capacity. In some embodiments, each optical output signal is split into three or more signal splits. The signal splits are attenuated to provide modified optical output signals. Each signal split receives a distinct degree of attenuation so that at least three distinct modified optical output signals are generated from each original optical output signal. The modified optical output signals are converted by optoelectronic transducers into electrical output signals having currents proportional to the strengths of the corresponding modified optical output signals. Transimpedance amplifiers within the EIC convert the electrical output signals from current signals into voltage signals. The voltages are then compared to a reference voltage. The results of these comparisons determine the digital encodings of the original optical output signals.

ADC divides the full range of optical powers for the analog optical signals into discrete levels, corresponding to the number of distinct values representable by the digital encoding. For an n-bit digital encoding, the optical power is divided into 2ⁿ discrete levels, with 2ⁿ−1 threshold voltages defining the boundaries between adjacent levels. Determining the discrete level into which an analog signal falls using a conventional ADC process involves comparisons using each of the 2ⁿ−1 threshold voltages.

In accordance with the present disclosure, each optical output signal is spilt into 2ⁿ−1 modified optical output signals, with each modified optical output signals subject to a distinct degree of attenuation. The attenuation levels may be selected so that all comparisons can be made using a single reference voltage. This approach eliminates the need for multiple reference voltages while maintaining accurate signal-level determination.

The attenuation levels may be selected so that each modified optical output signal aligns with the reference voltage when the original optical signal reaches a corresponding threshold amplitude. For instance, in a 2-bit conversion, the thresholds are typically set at 25%, 50%, and 75% of the maximum optical power. The attenuations are configured so that, at each threshold level, one of the modified optical output signals is reduced to a strength that, when transduced, matches the reference voltage. An example implementation involves generating three modified optical output signals: one with no attenuation, a second with a 50% signal strength reduction, and a third with a two-thirds reduction. In this example, the reference voltage corresponds to the unattenuated signal when the original optical signal reaches 25% of the maximum optical power.

The attenuations should be monotonic, ensuring that higher value inputs result in higher output values after attenuation. However, the attenuations need not be made in proportional to the original optical power. For example, in a 2-bit conversion, the attenuations levels for the three modified optical output signals could correspond to power reductions of 25%, 50%, and 75% of the maximum optical power. In this configuration, the reference voltage would correspond to zero optical power.

In some embodiments, attenuation is performed by a microring resonator (MRR), which may be configured as a two-port or four-port device. In some embodiments, attenuation is achieved through a Mach Zehnder interferometer (MZI). In some embodiments, attenuation is effectuated by splitting. In some embodiments, attenuation is performed by a variable optical attenuator (VOA). The VOA may be an MRR, an MZI, a splitter, or a waveguide with an integrated modulator segment.

In some embodiments, VOAs are used to adjust the attenuation strengths using feedback from the EIC. Calibration signals may be sent to the optical core, and the resulting electrical output signals may be analyzed to assess whether the attenuation levels are too high, too low, or within the specified range. Adjustments to the attenuation levels can then be made via control signals sent from the EIC to the VOAs. This comparison and adjustment process may occur periodically or dynamically and ensures accuracy in the ADC process.

In some embodiments, the PIC spatially splits the optical output signals, with each split directed along a distinct optical path. Each optical path applies a distinct level of attenuation and terminates at a separate optoelectronic transducer. The number of signal splits required for ADC is 2ⁿ−1 for each optical output signal. An even distribution between two paths can be achieved using a Y-splitter. A cascade of Y-splitters can produce 2ⁿ signal splits, resulting in one additional split. In some embodiments, the extra signal split is processed alongside the others to provide a reference signal. In some embodiments, the reference signal is compared to the other signals and the results are used to fine-tune the attenuation levels.

The approach of spatially splitting the optical output signals provides the highest processing speed but uses at least N×(2ⁿ−1) optoelectronic transducers and transimpedance amplifiers for N output signals. In some other embodiments, the PIC performs temporal splitting, where each optical output signal is divided across distinct time intervals. This approach reduces the number of optoelectronic transducers, transimpedance amplifiers, and electrical output connections, though it may decrease computational speed. In some embodiments, the PIC employs a hybrid approach that combines spatial and temporal splitting. For example, each optical output signal may be split across four spatially distinct paths, with each path applying a different level of attenuation in each of four successive time intervals. This hybrid configuration balances the trade-offs between the number of optical paths and computational speed, offering a scalable solution for various applications.

In some embodiments, the set of electrical signals corresponding to one of the optical output signals are measured and compared to one another. The results of the comparisons are used to adjust attenuations levels. In some embodiments, the currents of the electrical output signals are measured and compared. In other embodiments, the voltages after transimpedance conversion are measurements and compared. In some embodiments, one of the modified optical output signals is unattenuated, and the attenuation levels for the other modified output signals are adjusted to align with the unattenuated signal. In some embodiments, the unattenuated signal is the reference signal that is not required for ADC.

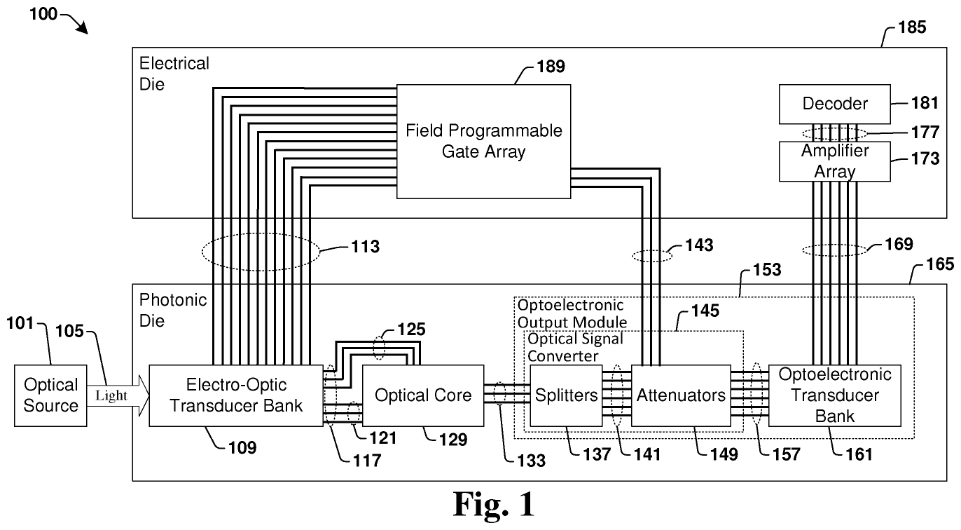

FIG. 1 provides a schematic illustration of an EPIC device 100 that embodies several aspects of the present disclosure. The EPIC device 100 include an EIC die 185, a PIC die 165, and an optical source 101. The EIC die 185 and the PIC die 165 may be bonded together in a chip package. In some embodiments the optical source 101 is incorporated into the PIC die 165. In some embodiments the optical source 101 is part of the chip package. In other embodiments, the optical source 101 resides externally and provides light through fiber-optic connections. The EIC die 185 includes a field programmable gate array (FPGA) 189. The PIC die 165 includes an electro-optic transducer bank 109, an optical core 129, and an optoelectronic output module 153.

The EIC die 185 transmits electrical input signals 113 via electrical interconnects to the PIC die 165. In certain embodiments, the electrical input signals 113 are generated by the FPGA 189. The electrical input signals 113 are digital representations of input data and kernel weights, with multiple electrical input signals 113 collectively encoding each input datum and each kernel weight. In some embodiments, the electrical input signals 113 are binary, carrying either a non-zero or zero voltage. Alternatively, the electrical input signals 113 can utilize non-return-to-zero (NRZ) encoding.

The optical source 101 provides light 105 which the electro-optic transducers 109 modulate to encode the electrical input signals 113 into optical input signals 117. The optical input signals 117 are analog. A first subset of the optical input signals 117 are optical input data 121, while a second subset of the optical input signals 117 are optical kernel weights 125. Each optical input datum 121 corresponds to a single input datum, and each optical kernel weight 125 corresponds to a single kernel weight, resulting in there being fewer optical input signals 117 than electrical input signals 113. In some embodiments, the optical source 101 is a coherent light source. The optical source 101 may be a laser source such as laser diode, the like, or any other suitable light source.

The optical core 129 transforms the optical input data 121 using a transformation function, with the optical kernel weights 125 serving as parameters, to generate the optical output signals 133. In some embodiments, the optical core 129 is configured as a convolutional unit, performing multiply-and-accumulate (MAC) operations using photonic components. More generally, the optical core 129 may support other linear transformations, such as matrix-vector or matrix-matrix multiplications, or other kernel-based operations, utilizing components such as microring resonators (MRRs) and Mach-Zehnder interferometers (MZIs) for efficient computation. Additionally, the optical core 129 may apply non-linear transformations or exploit non-linear optical effects (e.g., the Kerr effect). Optical switches or routers may be included to enable adaptive computation. Quantum optical elements may be included for operations involving quantum phenomena.

The optoelectronic output module 153 converts optical output signals 133 into electrical output signals 169 using optoelectronic transducers 161. In some embodiments, the optoelectronic transducers 161 are photodiodes, such as standard photodiodes or avalanche photodiodes. Standard photodiodes offer high fidelity, while avalanche photodiodes excel at detecting weak signals, making them particularly useful when the optoelectronic output module 153 attenuates the optical output signals 133 as part of its operation. Alternatively, the optoelectronic transducers 161 may be, phototransistors, graphene photodetectors, quantum dot photodetectors, the like, or any other suitable type of optoelectronic transducer.

In some embodiments, the optoelectronic transducers 161 operate directly on the optical output signals 133. In other embodiments, the optoelectronic output module 153 includes an optical signal converter 145, which transforms the optical output signals 133 into modified optical output signals 157 that are then transduced by the optoelectronic transducers 161.

The optical signal converter 145 includes splitters 137 and attenuators 149. The splitters 137 divide each optical output signal 133 into multiple signal splits 141. The attenuators 149 generate modified optical output signals 157 by applying varying degrees of attenuation to each of the signal splits 141 corresponding to one of the original optical output signals 133. Accordingly, the attenuators 149 are provided in sets, with one set of attenuators 149 provided for each optical output signal 133. The attenuators 149 may be powered by electrical control signals 143 generated by the EIC die 185 and transmitted to the PIC die 165 via electrical interconnects. In some embodiments, the electrical control signals 143 are used to dynamically adjust attenuation levels.

The electrical output signals 169 are transmitted via electrical interconnects to the EIC die 185, where amplifiers 173 amplify them to produce amplified electrical output signals 177. In some embodiments, the electrical output signals 169 are transmitted to the EIC die 185 as current signals, and the amplifiers 173 are transimpedance amplifiers (TIAs) that convert them into voltage signals. Alternatively, the amplifiers 173 may be voltage amplifiers, current amplifiers, the like, or any other suitable type of amplifiers.

Decoders 181 compare each amplified electrical output signal 177 to one or more reference voltages and use the comparison results to generate a digital encoding of the optical output signals 133. In some embodiments, the optoelectronic output module 153 produces modified optical output signals 157 that allow each amplified electrical output signal 177 to be compared against a single reference voltage, requiring only one comparison per signal. This approach accelerates analog-to-digital conversion by offloading a significant portion of the processing to the PIC die 165.

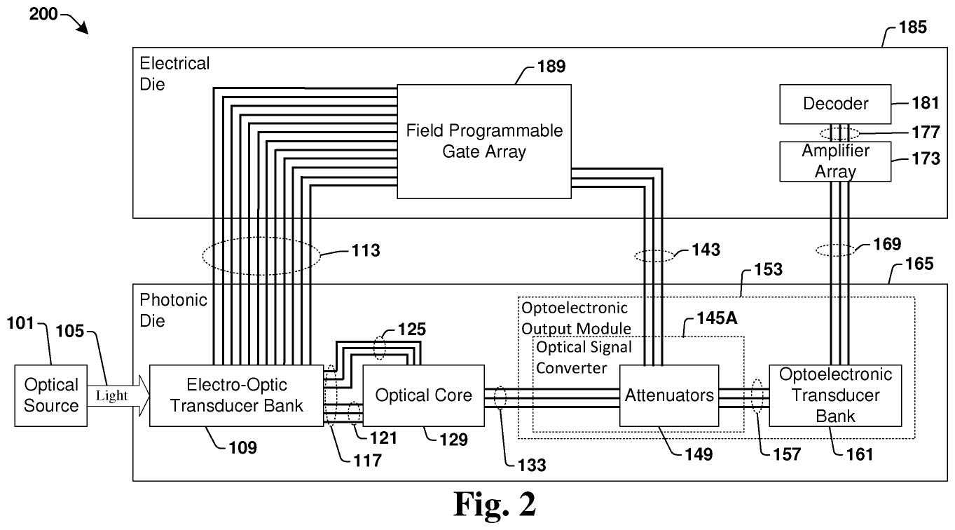

FIG. 2 provides a schematic illustration of an EPIC device 200 according to another embodiment. The EPIC device 200 is similar to the EPIC device 100 of FIG. 1, except it includes the optical signal converter 145A. The optical signal converter 145A may omit the splitters 137 (see FIG. 1) used to spatially divide the optical output signals 133. Instead, the optical signal converter 145A uses electrical control signals 143 to enable time-division multiplexing, applying varying degrees of attenuation to the modified optical output signals 157 over successive time intervals. While this approach may be slower than spatially dividing the optical output signals 133 for parallel processing, it reduces the number of attenuators 149, optoelectronic transducers 161, and amplifiers 173 required.

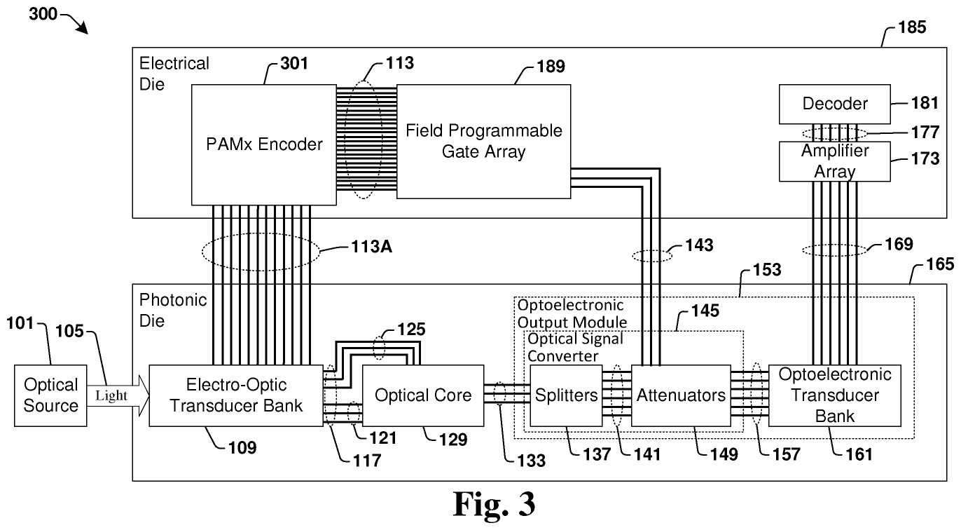

FIG. 3 provides a schematic illustration of an EPIC device 300 according to another embodiment. The EPIC device 300 is similar to the EPIC device 100 of FIG. 1, except it includes the PAMx encoder 301. The PAMx encoder 301 may be a PAM4 encoder, a PAM8 encoder, a PAM16 encoder, or other suitable PAMx encoder. The PAMx encoder 301 generates PAMx-encoded electrical signals 113A from binary electrical input signals 113. The PAMx-encoded electrical signals 113A are digital representations of input data and kernel weights, with multiple PAMx-encoded electrical signals 113A collectively encoding each input datum and each kernel weight. The electro-optic transducers 109 convert the PAMx-encoded electrical signals 113A into optical input signals 117, which are analog, resulting in fewer optical input signals 117 than PAMx-encoded electrical signals 113A. The PAMx encoding of the binary electrical inputs signals 113 may be considered a first step in digital-to-analog conversion, which is completed by the electro-optic transducers 109.

The electro-optic transducers 109 may be any type that incorporates voltage-controlled modulator segments. Examples include Mach-Zehnder modulators (MZMs), microring modulators (MRMs), and the like. Each electro-optic transducer 109 comprises at least as many modulator segments as the number of binary electrical input signals 113 or PAMx-encoded electrical signals 113A used to collectively encode each input datum and each kernel weight.

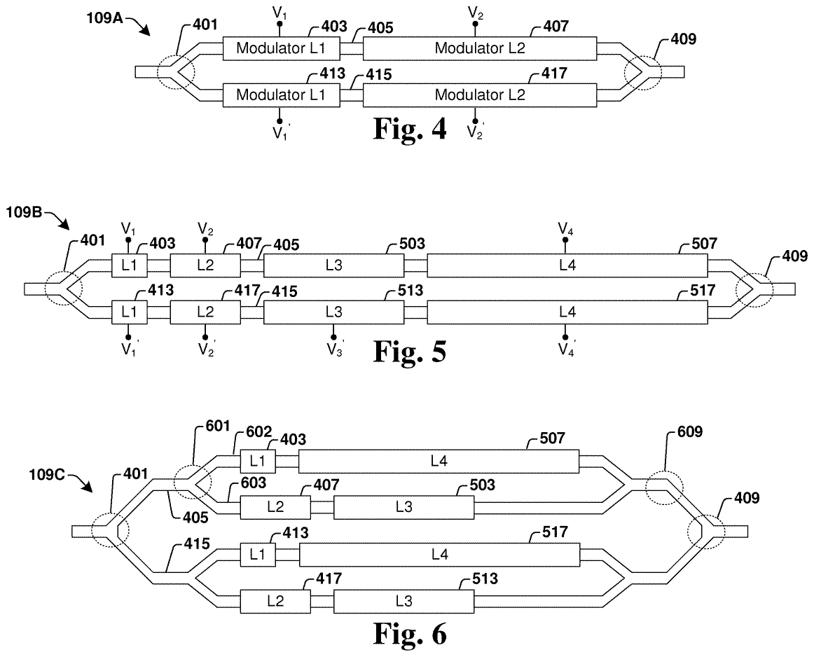

FIG. 4 illustrates a plan view of an electro-optic transducer 109A in accordance with a first embodiment. The electro-optic transducer 109A has the structure of a Mach-Zehnder modulator (MZM) including a splitter 401, a first arm 405, a second arm 415, and a combiner 409. The first arm 405 and the second arm 415 are waveguides. A first modulator segment 403 and a second modulator segment 407 are spaced apart along the first arm 405. The first modulator segment 403 and the second modulator segment 407 are independently controlled by voltages V₁ and V₂, respectively. The first and second voltages V₁ and V₂ may be provided by either binary electrical input signals 113 or PAMx-encoded electrical signals 113A.

The first and second modulator segments 403 and 407 have distinct modulation efficiencies. In some embodiments, the voltages V₁ and V₂ are binary-encoded signals, and the second modulator segment 407 has twice the modulation efficiency of the first modulator segments 403. In other embodiments, the voltages V₁ and V₂ are PAMx-encoded signals, and the second modulator segment 407 has x-times the modulation efficiency of the first modulator segment 403. These relationships are designed to efficiently encode digital information transmitted by modulating the voltages V₁ and V₂ into optical signals. For many types of modulators, the lengths of the first and second modulator segments 403 and 407 are proportional to their modulation efficiencies.

The first and second arms 405 and 415, as well as other waveguides described in this disclosure, may include rib waveguides, strip waveguides, or any other suitable waveguide geometry. The waveguides may have any suitable material composition to meet specific optical and system requirements. In some embodiments, the waveguides are semiconductor-based, such as silicon waveguides, which are compatible with CMOS processes and enable the confinement of light at sub-micron scales. In other embodiments, the waveguides may be composed of indium phosphide (InP) or the like to support nonlinear optical effects and efficient interaction with active photonic components. Additionally, the waveguides may be silicon nitride (SiN) or the like, which offer low propagation losses and precise phase control over a broad wavelength range. Different waveguide types and compositions may be used throughout the system to optimize performance for various tasks, such as modulation, signal routing, and kernel-based transformations.

The first and second modulator segments 403 and 407, may be carrier-depletion modulators, thermos-optic modulators, electro-absorption modulators, plasmonic modulators, Kerr-effect modulators, or any other type of modulator that may be applied to a segment of a waveguide to selectively alter a transmission characteristic in accordance with a voltage. In some embodiments, the modulator segments 403 and 407 are phase-modulating types such as carrier-depletion modulators, plasmonic modulators, or Kerr-effect modulators. In particular, the modulator segments 403 and 407 may be carrier-depletion modulators or the like. Carrier-depletion modulators are high speed, energy-efficient, and CMOS process compatible. Carrier-depletion modulators are typically formed by doping sections of a semiconductor waveguide to form p-n or p-i-n junctions.

In some embodiments, a first mirroring modulator segment 413 and a second mirroring modulator segment 417 are spaced apart along the second arm 415. The first mirroring modulator segment 413 may have the same structure as the first modulator segment 403, and the second mirroring modulator segment 417 may have the same structure as the second modulator segment 407. Including these mirroring modulator segments in the second arm 415 helps ensure that the optical path lengths in the first arm 405 and the second arm 415 are equal.

The first mirroring modulator segment 413 is controlled by voltage V₁′, and the second modulator segment 407 is controlled by voltage V₂′. In some embodiments, V₁′ is related to V₁, and V₂′ is related to V₂. In some embodiments, the voltages V₁′ and V₂′ are identical to V₁ and V₂ but applied with opposite polarity. Alternatively, V₁′ and V₂′ may be identical to V₁ and V₂ and applied with the same polarity. In other embodiments, V₁′ and V₂′ may be ground or reference voltages.

FIG. 5 illustrates a plan view of an electro-optic transducer 109B in accordance with a second embodiment. The electro-optic transducer 109B is similar to the electro-optic transducer 109A of FIG. 4 but has third and fourth modulator segments 503 and 507 in the first arm 405, and third and fourth mirroring modulator segments 513 and 517 in the second arm 415. The additional modulator segments allow the electro-optic transducer 109B to encode a greater number of digital electronic data bits into an analog optical signal.

The third and fourth modulator segments 503 and 507 are controlled by voltages V₃ and V₄, respectively. The third and fourth mirroring modulator segments 513 and 517 are controlled by voltages V₃′ and V₄′, which may be related to V₃ and V₄, respectively. The modulation efficiency ratios between the fourth modulator segment 507 and the third modulator segment 503, between the third modulator segment 503 and the second modulator segment 407, and between the second modulator segment 407 and the first modulator segment 403 may all be equal.

FIG. 6 illustrates a plan view of an electro-optic transducer 109C in accordance with a third embodiment. The electro-optic transducer 109C has the same modulator segments with the same voltage controls as the electro-optic transducer 109B of FIG. 5, but the modulator segments are arranged in a mixed series-parallel configuration. In particular, the first arm 405 includes a splitter 601 that divides the optical path between a first sub-arm 602 and a second sub-arm 603. The first sub-arm 602 contains the first modulator segment 403 and the fourth modulator segment 507, while the second sub-arm 603 contains the second modulator segment 407 and the third modulator segment 503. A combiner 609 then joins the first sub-arm 602 and the second sub-arm 603, causing their optical signals to interfere. The second arm 415 has a mirroring arrangement of the first arm's configuration. The mixed series-parallel configuration may provide a more effective combination of amplitude and phase encoding compared to either purely series or purely parallel arrangement.

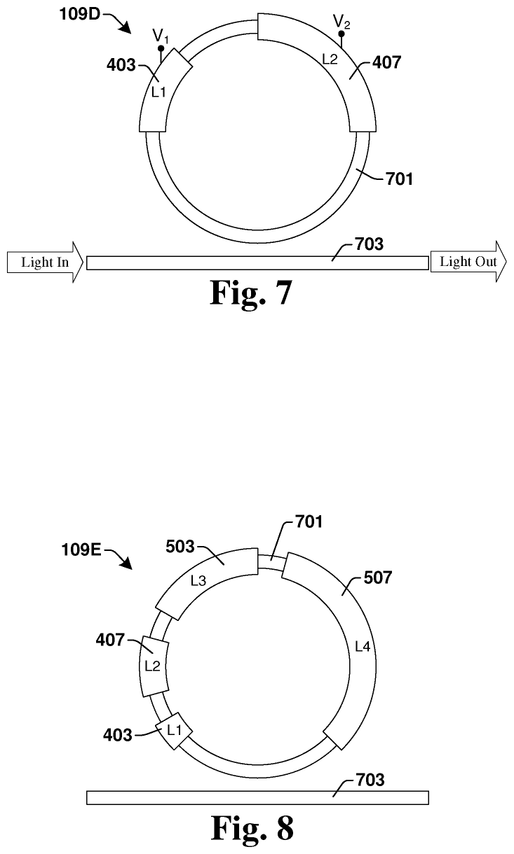

FIG. 7 illustrates a plan view of an electro-optic transducer 109D in accordance with a fourth embodiment. The electro-optic transducer 109D is a microring modulator (MRM) that incorporates the first and second modulator segments 403 and 407 within a ring-shaped waveguide 701. The ring-shaped waveguide 701 is optically coupled to a bus waveguide 703. The voltages V₁ and V₂ applied to the first and second modulator segments 403 and 407 control the phase shift of light as it enters and exits the bus waveguide 703.

FIG. 8 illustrates a plan view of an electro-optic transducer 109E in accordance with a fifth embodiment. The electro-optic transducer 109E is similar to the electro-optic transducer 109D of FIG. 7, but it incorporates the third and fourth modulator segments 503 and 507, in addition to the first and second modulator segments 403 and 407, to increase the number of bits of information that may be encoded into the optical signal.

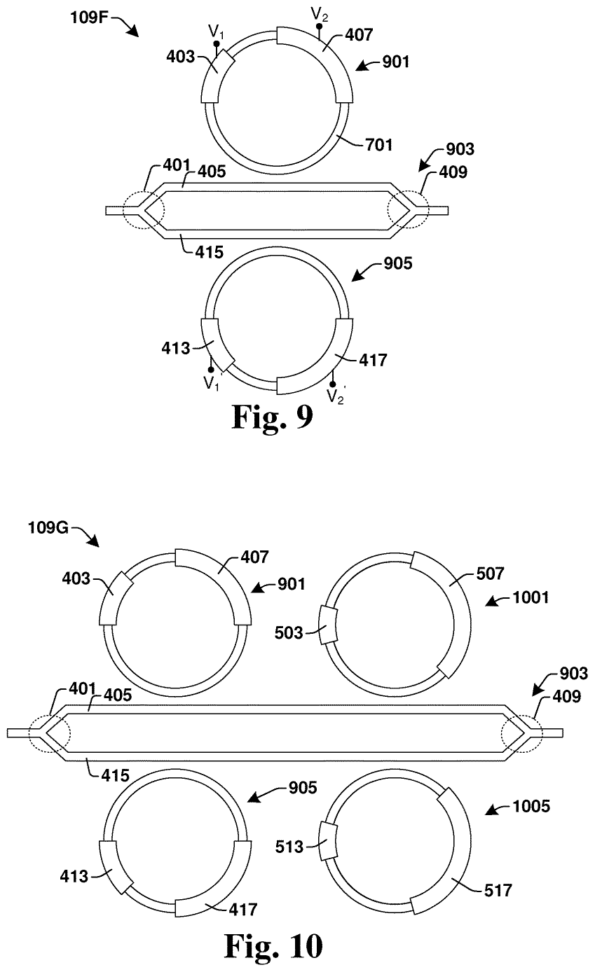

FIG. 9 illustrates a plan view of an electro-optic transducer 109F in accordance with a sixth embodiment. The electro-optic transducer 109F includes a first microring resonator 901 optically coupled to the first arm 405 of a Mach-Zehnder interferometer (MZI) structure 903. The first microring resonator 901 incorporates the first modulator segment 403 and the second modulator segment 407. A second microring resonator 905 is coupled to the second arm 415 of the MZI in a mirroring arrangement, which includes the first and second mirroring modulator segments 413 and 417. This configuration leverages the combined properties of microring resonators and MZI structures to enable optical modulation with precise control of phase and amplitude. In an alternative embodiment, the second microring resonator 905 incorporates modulator segments with distinct lengths and independent control signals from the first and second modulator segments 403 and 407, enabling the encoding of additional bits.

FIG. 10 illustrates a plan view of an electro-optic transducer 109G in accordance with a seventh embodiment. The electro-optic transducer 109G is similar to the electro-optic transducer 109F shown in FIG. 9 but includes a third microring resonator 1001 arranged in series with the first microring resonator 901 along the first arm 405. The third microring resonator 1001 incorporates the third and fourth modulator segments 503 and 507. A fourth microring resonator 1005, which incorporates the third and fourth mirroring modulator segments 513 and 517, is positioned along the second arm 415 in a mirroring arrangement. The addition of the third microring resonator 1001 enables the encoding of additional bits. The addition of the fourth microring resonator 1005 may maintain optical path length equivalence, enable push-pull operation, or provide further encoding capacity.

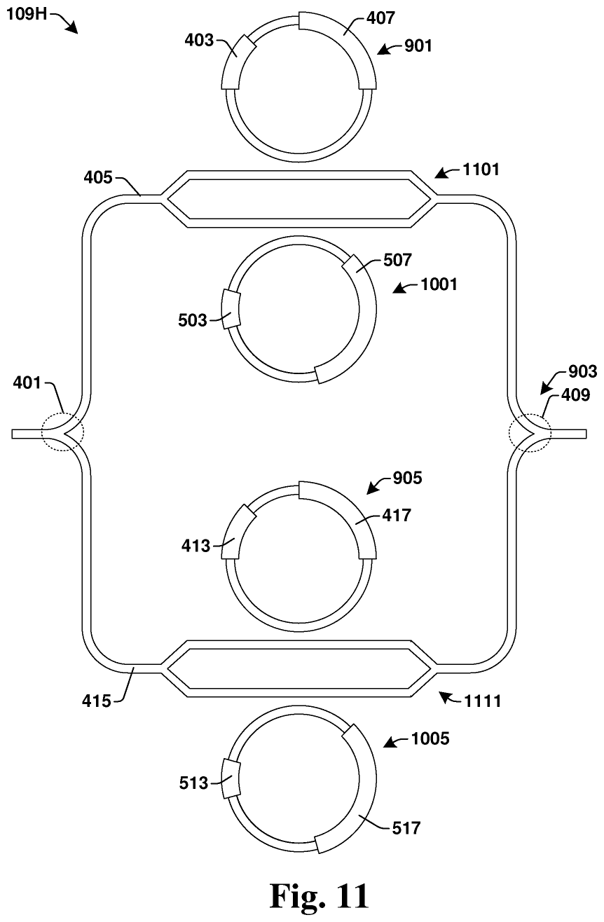

FIG. 11 illustrates a plan view of an electro-optic transducer 109H in accordance with an eighth embodiment. The electro-optic transducer 109H has the same components as the electro-optic transducer 109G shown in FIG. 10 but arranges the first and third microring resonators 901 and 1001 in parallel on opposite arms of a secondary MZI structure 1101 within the first arm 405. Similarly, the second and fourth microring resonators 905 and 1005 are arranged in parallel on opposite arms of a secondary MZI structure 1111 within the second arm 415. This arrangement may provide a more effective distribution between amplitude and phase encoding than alternate configurations using the same components.

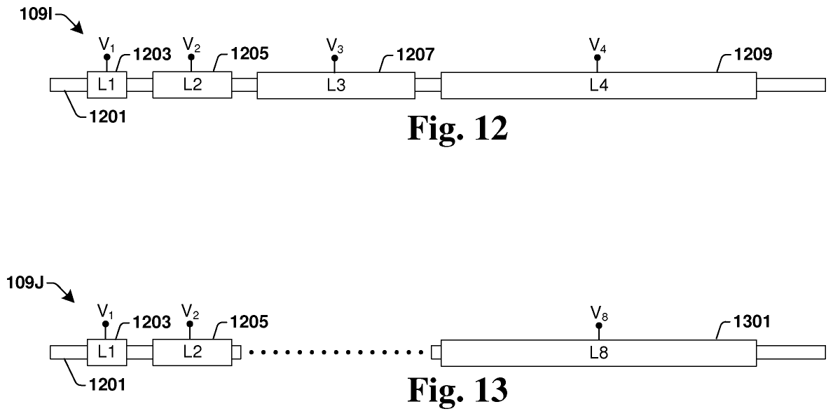

FIG. 12 illustrates a plan view of an electro-optic transducer 109I in accordance with a ninth embodiment. The electro-optic transducer 109I includes modulator segments 1203, 1205, 1207, and 1209 along a waveguide 1201. The modulator segments 1203, 1205, 1207, and 1209 are voltage-controlled attenuators. In some embodiments, these voltage-controlled attenuators provide an amplitude drop that is independent of the input signal's amplitude. Examples of such attenuators may include carrier-depletion attenuators, electro-absorption attenuators, thermo-optic attenuators, plasmonic attenuators, and the like. In certain embodiments, the voltage-controlled attenuators are carrier-depletion attenuators. Carrier-depletion attenuators are high speed, energy-efficient, and compatible with CMOS processes.

A carrier-depletion attenuator can be regarded as a carrier-depletion modulator with specific design characteristics. A carrier-depletion modulator can be designed so that the carrier depletion induced by the applied voltage changes the refractive index of the waveguide, producing a phase shift with minimal light absorption. With higher doping concentrations, the carrier-depletion modulator can be designed to introduce significant absorption, achieving a fixed attenuation level that is independent of the input signal's intensity, with minimal phase impact. Intermediate designs balancing phase modulation and absorption are also possible.

The modulator segments 1203, 1205, 1207, and 1209 provide distinct amounts of attenuation. In some embodiments, the modulator segments 1203, 1205, 1207, and 1209 have distinct lengths. The lengths may be proportional to amounts of attenuation. In some embodiments, the amounts of attenuation differ by a factor of two. For example, if the modulator segment 1209 drops 50% of maximum signal strength, the modulator segments 1203, 1205, and 1207 may drop 6.25%, 12.5%, and 25%, respectively. In some embodiments, the electrical signals use PAM4 encoding, with the attenuation levels differing by a factor of four. More generally, the electrical signals may use PAMx encoding, where the attenuation amounts scale by a factor of x, where x is a positive integer power of 2 (e.g., 8, 16, etc.). Designing the modulator segments according to these relationships enables efficient data encoding.

FIG. 13 illustrates a plan view of an electro-optic transducer 109J in accordance with a tenth embodiment. The electro-optic transducer 109J is similar to the electro-optic transducer 109I shown in FIG. 12 but includes additional modulator segments 1301 providing, for example, a total of eight modulator segments. The additional modulator segments 1301 increase the number of bits of information that can be encoded into the optical signal.

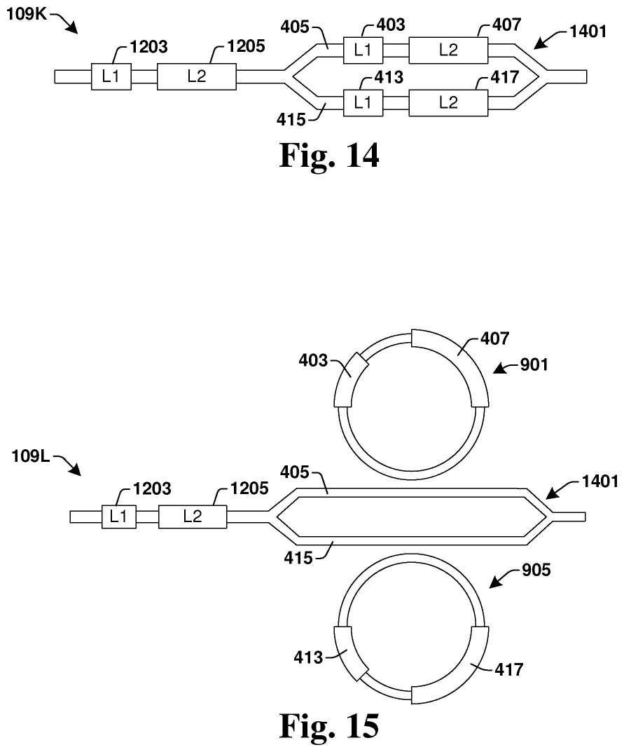

FIG. 14 illustrates a plan view of an electro-optic transducer 109K in accordance with an eleventh embodiment. The electro-optic transducer 109K combines voltage-controlled attenuators, as shown in FIG. 12, with an MZM structure, as shown in FIG. 4. Specifically, the electro-optic transducer 109K includes modulator segments 1203 and 1205, which are voltage-controlled attenuators, along with the first and second modulator segments 403 and 407 in the first arm 405 of an MZI structure 1401, and the first and second mirroring modulator segments 413 and 417 in the second arm 415 of the MZI structure 1401. Applying attenuation alone limits the number of bits that can be discriminated within the optical signal. A combined structure, such as the electro-optic transducer 109K, mixes phase and amplitude encoding to increase the number of bits of information that can be discriminated within the optical signal.

FIG. 15 illustrates a plan view of an electro-optic transducer 109L in accordance with a twelfth embodiment. The electro-optic transducer 109L combines voltage-controlled attenuators, as shown in FIG. 12, with a microring resonator structure, as shown in FIG. 9. Specifically, the electro-optic transducer 109L includes modulator segments 1203 and 1205, which are voltage-controlled attenuators, along with the first and second modulator segments 403 and 407, located within the microring resonator 901, and the first and second mirroring modulator segments 413 and 417, located within the microring resonator 905. The microring resonators 901 and 905 are coupled to the first and second arms 405 and 415 of the MZI structure 1401, respectively. The electro-optic transducer 109L exemplifies another method of combining phase and amplitude encoding to increase the number of bits of information that can be encoded into, and discriminated within, the optical signal.

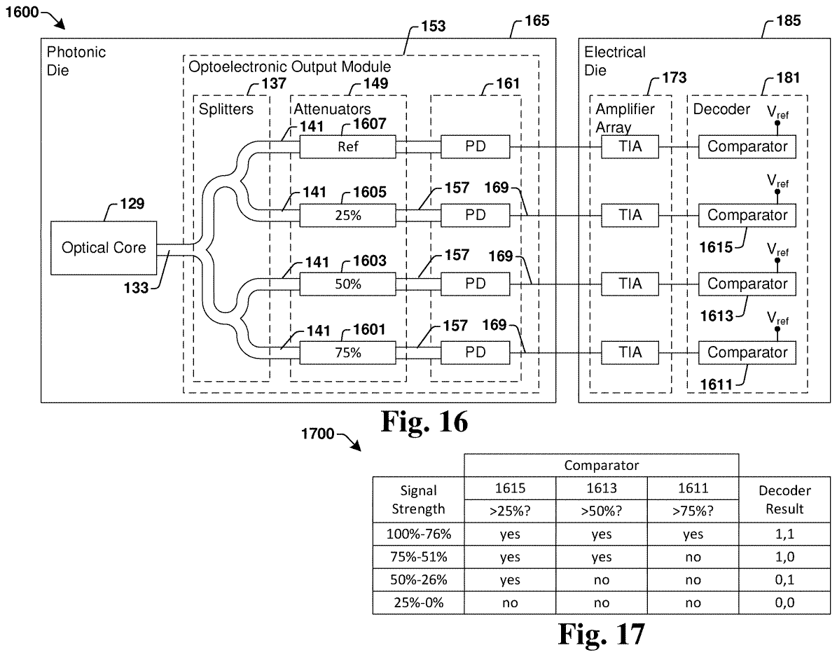

FIG. 16 provides a schematic illustration 1600, focusing on a portion of the EPIC device 100 shown in FIG. 1 that processes the optical output signal 133 from the optical core 129, in accordance with an embodiment of the present disclosure. The example illustrates the processing of a single optical output signal 133. If there are N optical output signals 133, the illustrated structure is repeated N times to enable parallel processing of all signals.

The splitter 137 divides the optical output signal 133 into 2ⁿ signal splits 141, where n represents the number of digital bits into which the optical output signal 133 is transduced. Of these, only 2ⁿ−1 signal splits 141 are required to provide the digital signal. The remaining signal split 141 may be discarded or used as a reference for error checking, fine-tuning, or other purposes.

The attenuators 1601, 1603, and 1605 in the attenuators 149 generate modified optical output signals 157. The modified optical output signals 157 are transduced into electrical output signals 169, amplified, and then compared against the reference voltage V_{ref} by the comparators 1611, 1613, and 1615 in the decoder 181. The decoder 181 analyzes the results using the truth table 1700 shown in FIG. 17 to determine the corresponding digital value.

As shown in the truth table 1700, the comparator 1615 determines whether the optical output signal 133 exceeds 25% of maximum signal power by comparing the amplified electrical signal transduced from the modified optical output signal 157 generated by the attenuator 1605 to V_{ref}. Similarly, the comparators 1613 and 1611 determine whether the optical output signal 133 exceeds 50% and 75% of maximum power, respectively, based on comparison of signals derived from the attenuators 1603 and 1601 with V_{ref}. For these comparisons to function correctly with all comparators 1611, 1613, and 1615 using the same reference level V_{ref}, the attenuators 1605, 1603, and 1601 are designed to produce modified optical output signals 157 with identical amplitudes when provided with optical output signals 133 at 25%, 50%, and 75% of maximum power, respectively.

In some embodiments, one of the attenuators, such as attenuator 1605 in this example, provides no attenuation, allowing it to directly distinguish optical output signals 133 in the lowest range (e.g., 0-25%) from those in the next range up (e.g., less than 50%). This setup establishes a 25% reference voltage level for all modified optical output signals 157 when at their respective thresholds. For attenuator 1603, the threshold is at 50%, and applying a 50% attenuation maps this threshold-level signal to the 25% reference voltage level. For attenuator 1601, the threshold is at 75%, and applying a ⅓ power reduction similarly maps signals at this higher threshold to the 25% reference voltage level. This tiered attenuation approach enables discrimination among multiple signal levels using a single reference voltage, ensuring accurate and simplified digital conversion.

In some embodiments, all attenuators 1605, 1603, and 1601 provide non-zero levels of attenuation. For instance, the attenuator 1605 may apply a 10% power reduction, with the reference voltage level adjusted downward to 22.5%, so that the output of attenuator 1605 falls above or below the reference voltage level depending on whether the optical output signal 133 exceeds 25% of maximum power. Similarly, attenuators 1603 and 1601 can be adjusted to provide 55% and 70% power reductions, respectively. This approach allows flexibility to adjust attenuation levels, a flexibility that may be used to compensate for variations in maximum power that may arise from uncontrolled factors.

In the foregoing examples, the attenuators apply a percentage-based reduction in input signal power. However, fixed-level attenuators—those that apply a constant attenuation independent of the input intensity—may also be used. In some embodiments, attenuators 1601, 1603, and 1605 provide such fixed attenuation levels, and the reference voltage level is zero. In this configuration, the attenuators 1601, 1603, and 1605 apply fixed power reductions to signal splits 141 that are designed to be 25%, 50%, and 75% of the maximum split signal power, respectively. Making the reference voltage level zero may enable the decoder 181 to have a simpler structure.

Attenuators that provide power reductions that are neither fixed absolute values nor fixed percentages of input signal power may also be used. The only requirements for attenuators 1601, 1603, and 1605 are that they map input signals above their respective reference power levels to above the threshold, input signals at their reference power levels to the threshold, and input signals below their reference power levels to below the threshold. While the examples provided have illustrated analog-to-digital conversion for 2-bit resolution, this approach can be readily extended to support 3-bit or higher digital conversion.

The examples thus far have assumed that the values represented by optical output signals 133 are directly proportional to their amplitudes. While this is typically the case, the system disclosed here accommodates any monotonic relationship between amplitude and value, including non-linear relationships. This flexibility in amplitude-to-value mapping increases the design options for the optical core 129. Non-linear signals can be interpreted and converted into corresponding digital values by configuring attenuators 1601, 1603, and 1605 to map amplitudes representing 0.75, 0.50, and 0.25, respectively, to the reference level.

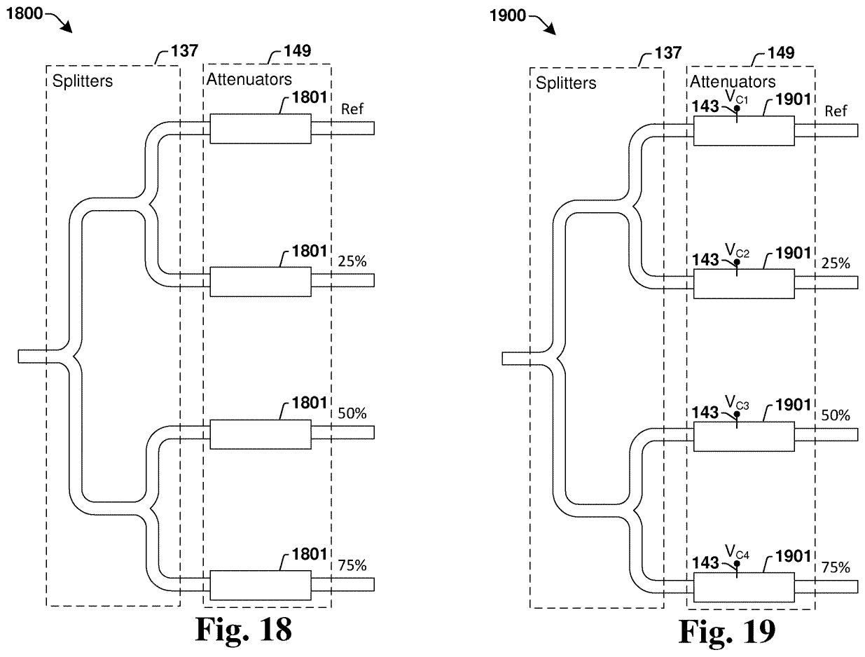

FIGS. 18 and 19 provide plan views 1800 and 1900, illustrating two approaches for implementing the attenuators 149. In the plan view 1800, the attenuators 149 consists of attenuators 1801 that inherently provide distinct attenuation levels. These attenuators may be or comprise, for example, microring resonators (MRRs), Mach-Zehnder interferometers (MZIs), optical splitters, fixed optical attenuators incorporating absorptive or scattering materials, and the like, as well as combinations thereof. In the plan view 1900, the attenuators 149 includes attenuators 1901 powered by electrical control signals 143. These voltage-controlled attenuators may be or comprise, for example, microring modulators (MRMs), Mach-Zehnder modulators (MZMs), carrier-depletion attenuators, electro-absorption attenuators, thermo-optic attenuators, plasmonic attenuators, the like, and combinations thereof.

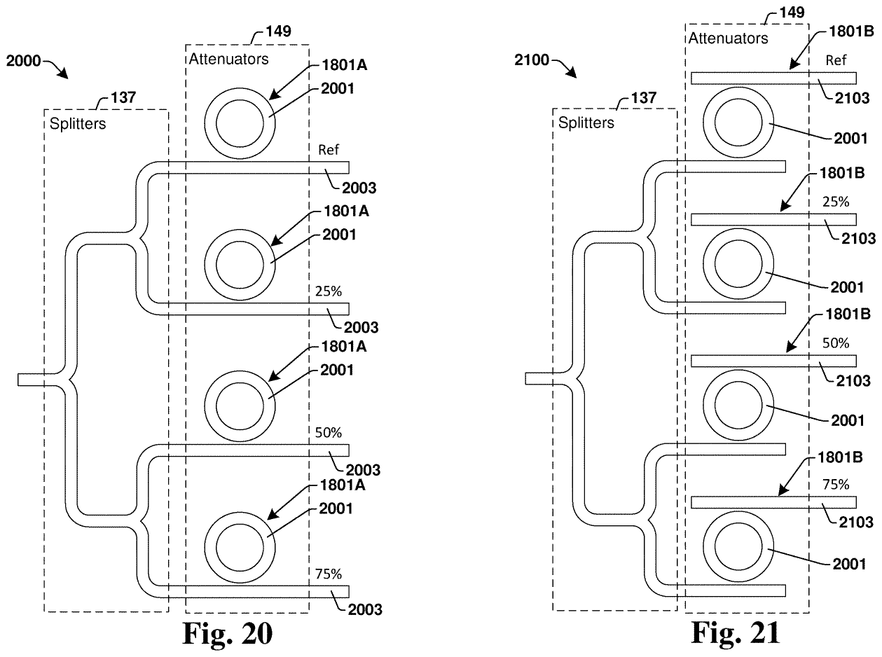

FIG. 20 illustrates a plan view 2000 of an embodiment where the attenuators 1801A are implemented as microring resonators (MRRs) 2001. Each MRR 2001 is coupled to a corresponding bus waveguide 2003 and is designed to resonate at or near the frequency of the light 105 generated by the optical source 101 shown in FIG. 1. To achieve different attenuation levels among the attenuators 1801A, the resonant frequencies of the MRRs 2001 or their distances from the bus waveguides 2003 (affecting the coupling coefficients) may be varied.

FIG. 21 illustrates a plan view 2100 of another embodiment in which the attenuators 1801B are implemented as MRRs 2001. This configuration differs from the plan view 2000 shown in FIG. 20 by providing output signals through second bus waveguides 2103 in a four-port mode, rather than through the bus waveguides 2003 in a two-port mode. The four-port mode offers more precise control over attenuation levels and introduces an additional parameter for varying the attenuation levels: the coupling coefficients between the MRRs 2001 and the second bus waveguides 2103.

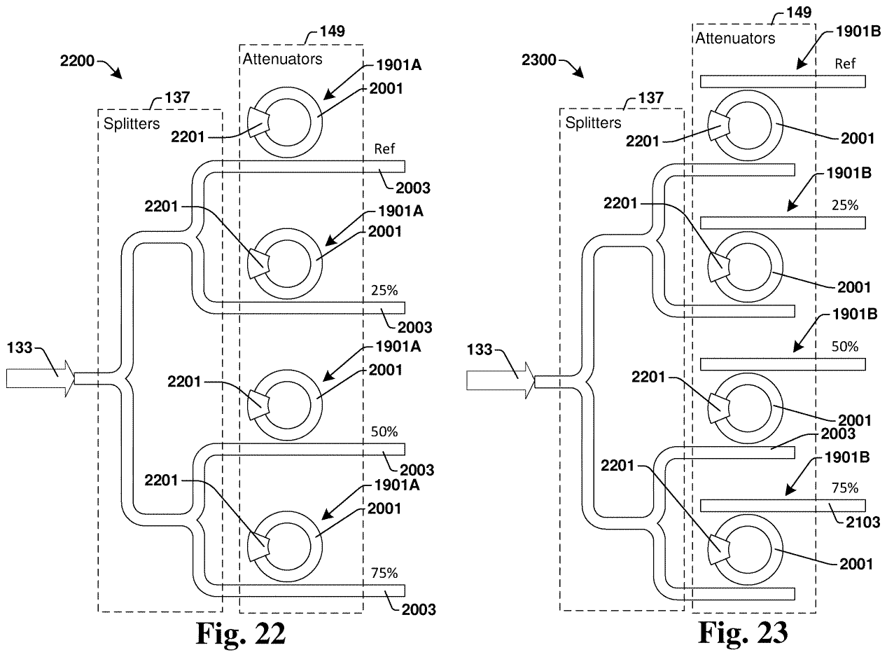

FIGS. 22 and 23 present plan views 2200 and 2300 showing additional embodiments. These additional embodiments correspond with those illustrated in plan views 2000 and 2100 (FIGS. 20 and 21), but with the addition of modulator segments 2201. The modulator segments 2201 are controlled by voltages V_{C1}-V_{C4}, as depicted in FIG. 19. The structures that process one of optical output signal 133 are shown in these drawings, but typically there are multiple optical output signals 133 and corresponding structures for each one. The voltages V_{C1}-V_{C4} (see FIG. 19) may be applied uniformly across all these structures. In some embodiments, the attenuators 1901A or 1901B have structural uniformity so that variations among attenuation levels are determined solely by the modulator segments 2201 and their controls. In other embodiments, structural variations, such as differences in resonant frequencies and coupling coefficients, vary the attenuation levels and the modulator segments 2201 provide fine-tuning adjustments via the control voltages V_{C1}-V_{C4}. In some embodiments, variation in attenuation levels caused by the modulator segments 2201 correspond to variations in the control voltages V_{C1}-V_{C4}. In other embodiments, variation in attenuation levels are determined at least in part based on differences in modulation efficiencies among the modulator segments 2201.

FIG. 24 illustrates a plan view 2400 of another embodiment of the attenuators 149. In this embodiment, the attenuators 1801C are implemented as Mach-Zehnder interferometers (MZIs), where each attenuator's attenuation level is determined by a difference in optical path lengths between the arms. The variation in optical path length differences enables distinct attenuation levels, allowing each attenuator 1801C to apply a predetermined degree of amplitude reduction.

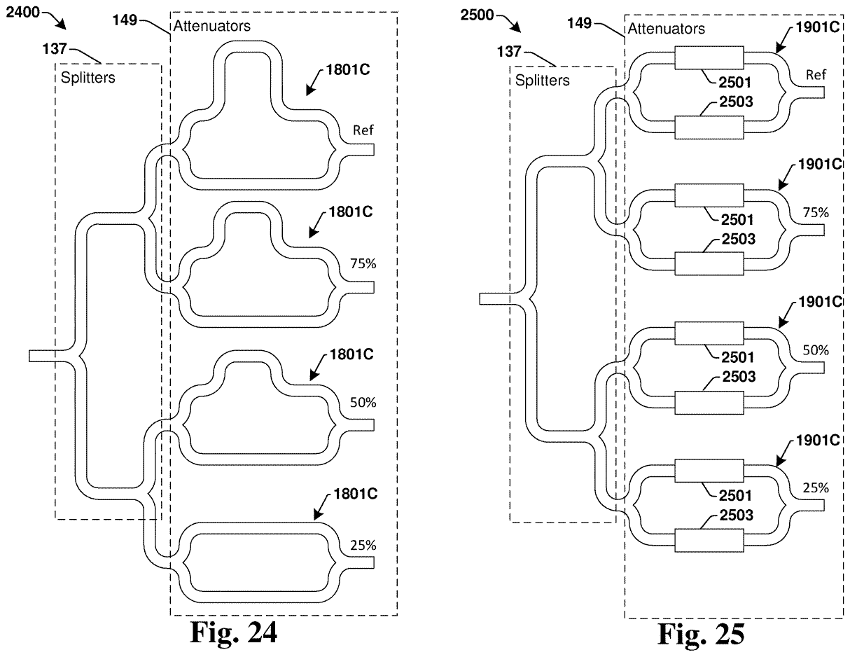

FIG. 25 illustrates a plan view 2500 of an embodiment of the attenuators 149. In this embodiment, the attenuators 1801C are implemented as Mach-Zehnder modulators (MZMs). These attenuators are similar to the attenuator 1801C of FIG. 24 but include modulator segments 2501 that may be used to vary, adjust, or fine-adjust attenuation levels. The attenuators 1901C may also include mirroring modulator segments 2503, which help maintain equal optical path lengths and enable push-pull operation, among other benefits. Differences in attenuation levels may be achieved through any suitable combination of arm length differentials, control voltages, and modulation efficiencies.

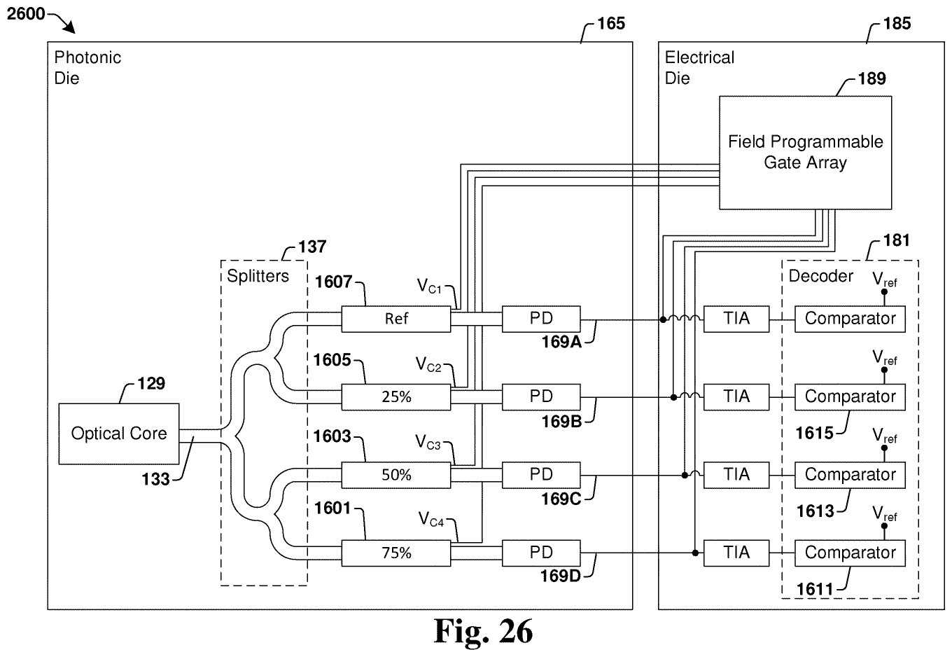

FIG. 26 provides a schematic illustration 2600, which corresponds to the EPIC device 100 of FIG. 1 in an embodiment where the electrical output signals 169 corresponding to one of the optical output signal 133 are measured and used to adjust the attenuation levels via the control signals V_{C1}-V_{C4}. The control signals V_{C1}-V_{C4} may be applied to all of the optical output signal 133, but the measurements need only be made for one of the optical output signals 133.

The adjustments may be made to ensure that the attenuation levels are aligned relative to each other. For instance, the attenuator 1607 may apply no power reduction, while the attenuators 1605, 1603, and 1601 may be intended to provide 10%, 55%, and 70% power reductions, respectively. The control signal V_{C2} is adjusted so that the electrical output signal 169B is 90% of the electrical output signal 169A. Similarly, the control signal V_{C3} is adjusted so that the electrical output signal 169C is 45% of the electrical output signal 169A, and the control signal V_{C4} is adjusted so that the electrical output signal 169D is 30% of the electrical output signal 169A.

In another example, the electrical output signal 169A-D are expected to have relative strengths of 100, 75, 50, and 25. The measurements, however, show relative strengths of 96, 76, 49, and 26. The control signals V_{C2}-V_{C4} are adjusted so that the relative strengths become aligned at 96, 72, 48, and 24. Many attenuation strategies are feasible, and many fine-tuning strategies are also feasible. The adjustments may be made with or without the reference signal, which corresponds to the electrical output signal 169A. The adjustments may be made with or without providing calibration data to the optical core. The adjustments may be made by comparing the electrical output signals 169A-D to one another, or by comparing the electrical output signals 169A-D against one or more reference values.

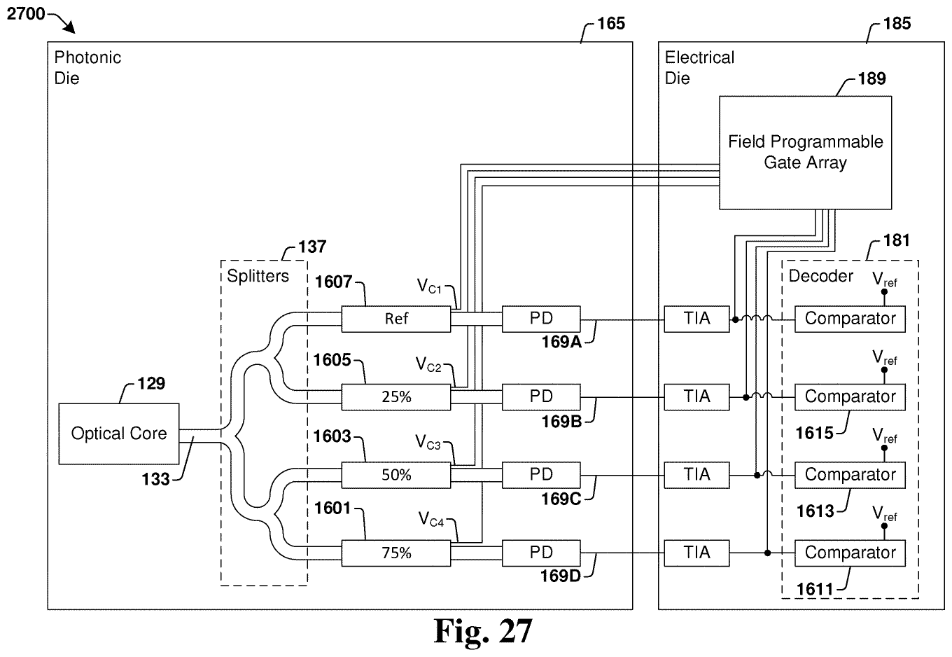

FIG. 27 provides a schematic illustration 2700, which is similar to the schematic illustration 2600 of FIG. 26, but is for an embodiment where the electrical output signals 169 are measured after transimpedance conversion. The voltage signals may be easier than the current signals to measure and compare.

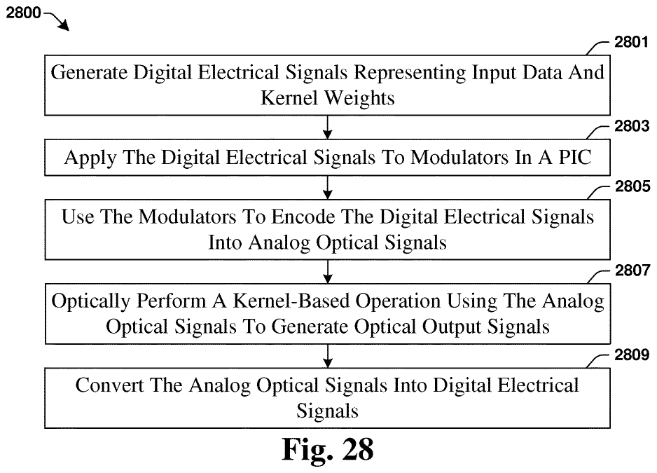

FIG. 28 provides a flow diagram for a method 2800 that includes optical DAC in accordance with some embodiments of the present disclosure. While the method 2800 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 2800 begins with act 2801, generating digital electrical signals representing input data and kernel weights. The digital electrical signals may use binary encoding, PAMx encoding, or any other suitable encoding scheme. For purposes of the present disclosure, a digital encoding may be any encoding scheme wherein each value is encoded by a plurality of distinct signals that must be interpreted together to decode the value.

Act 2803 is applying the digital electrical signals to modulators within a PIC. This act includes transmitting the digital electrical signals from an EIC to the PIC. Each digital electrical signal is coupled to at least one distinct modulator, allowing respective modulators to be controlled by respective electrical signals. Each electrical signal may be applied to a plurality of modulators, but there must be at least one distinct modulator for each digital electrical signal.

Act 2805 is using the modulators to encode the digital electrical signals into analog optical signals. The modulators are configured and arranged such that all digital electrical signals corresponding to a single input datum or kernel weight are collectively encoded into one analog optical signal, with each digital signal exerting an independent and distinct effect on the optical signal. This configuration ensures that the analog optical signal accurately represents the complete data for each input datum or kernel weight. The optical signal may use amplitude encoding, phase encoding, a combination thereof, or any other suitable encoding scheme. The optical signals are analog in the sense that each one represents a continuous range of values and can be decoded independently of any other optical signal. FIGS. 4-15 provide illustrative examples of modulator arrangements that may achieve this digital-to-analog conversion.

Act 2807 is optically performing a kernel-based operation in which a first portion of the analog optical signals represent input data, and a second portion of analog optical signals represent kernel weights, to generate optical output signals. The kernel-based operation may be a multiply and accumulate operation (MAC) or some other transformation that combines or processes the input data and the kernel weights.

Act 2809 is converting the optical output signals, which are analog, to digital electrical signals. This ADC may be accomplished using one or more stages or methods described in the present disclosure or by any other suitable technique.

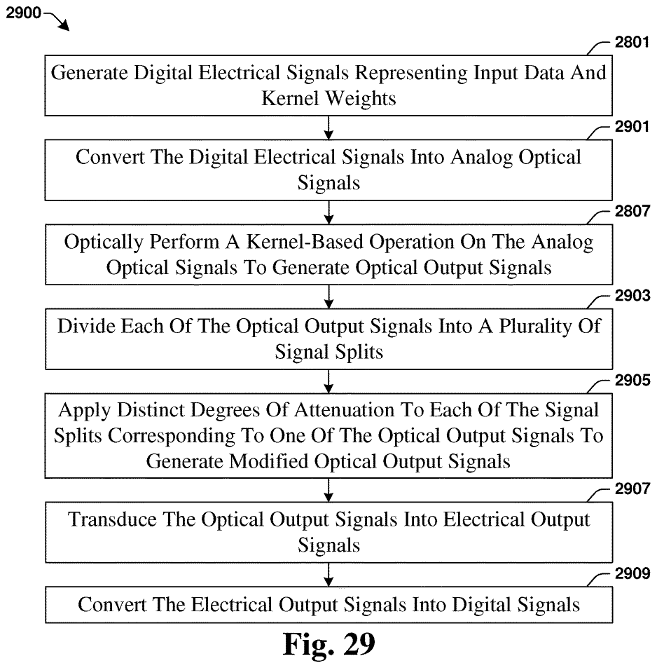

FIG. 29 provides a flow diagram for a method 2900 that includes converting analog optical signals into digital electrical signals in accordance with some embodiments of the present disclosure. While the method 2900 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 2900 begins with act 2901, generating digital electrical signals representing input data and kernel weights. This may be the same as in the method 2800 of FIG. 28.

Act 2901 is converting the digital electrical signals into analog optical signals. This may be accomplished by acts 2803 and 2805 in the method 2800 of FIG. 28 or by any other suitable method.

Act 2805 is using the modulators to encode the digital electrical signals into analog optical signals. This may be the same as in the method 2800 of FIG. 28.

Act 2903 is dividing each analog optical signal into a plurality of signal splits, which may be achieved through spatial, temporal, or hybrid splitting techniques. FIG. 16 provides an illustrative example of spatial splitting.

Act 2905 is applying distinct degrees of attenuation to each of the signal splits. The same set of attenuation levels is applied to each group of signal splits corresponding to an optical output signal. One of the signal splits may receive no attenuation. The signals splits, post attenuation, are referred to as modified optical output signals. FIG. 18-25 provide examples of optical circuits for achieving these attenuation levels. In some examples, attenuation levels are electronically controlled and can be fine-tuned using feedback control mechanisms. Additionally, in some of these configurations, electronic control enables the use of temporal signal splitting rather than spatial splitting.

Act 2907 is transducing the optical output signals into electrical output signals. This may include using optoelectronic transducers to convert the modified optical output signals into electrical current signals and employing transimpedance amplifiers to convert these current signals into voltage signals.

Act 2909 comparing the voltage signals to one or more reference voltages and using the results of these comparisons to determine the digital encoding. In some embodiments, the attenuation levels specified in Act 2905 are configured so that all comparisons can be made using only a single reference voltage.

Some aspects of the present disclosure relate to a chip package that includes a package substrate, an optical engine, and a fiber mounting unit. The optical engine includes a photonic integrated circuit die and an electrical integrated circuit die mounted to and electrically coupled with the package substrate. The photonic integrated circuit die includes an edge coupler. The fiber mounting unit is a structure that is mounted to the package substrate side-by-side with the optical engine and has a first cavity positioned to hold an optical fiber in alignment with the edge coupler.

Some aspects of the present disclosure relate to a photonic integrated circuit (PIC) device that includes optical modulators, an optical core, and an optoelectronic output module. The optical modulators are each configured to transduce electrical input signals to produce optical input signals. At least one of the optical modulators comprises two or more modulator segments controlled by distinct electrical input signals, such that the corresponding optical input signal is determined based on a combination of the electrical input signals. The optical core is configured to perform kernel-based operations on the optical input signals to generate optical output signals. The optoelectronic output module include optoelectronic transducers and is configured to convert the optical output signals into electrical output signals. In some embodiments, the optoelectronic output module is configured to provide three or more of the electrical output signals from one of the optical output signals.

In some embodiments the modulator segments have distinct modulation efficiencies. In some embodiments one of the modulator segment has at least two times the modulation efficiency of another. In some embodiments one of the modulator segment has at least four times the modulation efficiency of another. In some embodiments there are at least three modulator segments, each having a distinct modulation efficiency. In some embodiments, the modulator segments have distinct lengths. In some embodiments, one modulator segment has a length that is an integer power of two times the length of a second. In some of these embodiments, a third modulator segment has a length that is an integer power of two times the length of the second.

In some embodiments, two of the modulator segments are positioned along a single arm of a Mach-Zehnder modulator. In some embodiments, two other modulator segments are positioned along the other arm. In some embodiments, two of the modulator segments are positioned along a ring-shaped waveguide. In some embodiments, two of the modulator segments are attenuators. In some embodiments, two of the modulator segments comprise p-n or p-i-n junctions in a waveguide

Some aspects of the present disclosure relate to an electronic-photonic integrated circuit (EPIC) device that includes an electrical integrated circuit (EIC) die, a photonic integrated circuit (PIC) die, and an optical source. The EIC die is configured to generate electrical input signals and receive electrical output signals. The PIC die includes optical modulators, an optical core, and an optoelectronic output module. The optical modulators are each configured to transduce electrical input signals to produce optical input signals by modulating light from the light source. At least one of the optical modulators comprises two or more modulator segments controlled by distinct electrical input signals, such that the corresponding optical input signal is determined based on a combination of the electrical input signals. The optical core is configured to perform kernel-based operations on the optical input signals to generate optical output signals. The optoelectronic output module include optoelectronic transducers and is configured to convert the optical output signals into the electrical output signals. In some embodiments, the EIC die includes a PAMx encoder that provides one of the electrical input signals. In some embodiments, the EIC die includes a field programmable gate array that provides the electrical input signals.

Some aspects of the present disclosure relate to a method that includes generating electrical signals representing digital input data and kernel weights and transmitting the electrical input signals to a PIC. Each input datum and each kernel weight is encoded across a plurality of the electrical signals. The method further includes modulating light based on the electrical signals, thereby generating optical input signals, and using an optical core to perform a kernel-based operation on a first portion of the optical input signals representing the input data using a second portion of the optical input signals to represent the kernel weights, and thereby generating optical output signals. In some embodiments, modulating light based on the electrical signals comprises applying each of the electrical signals to a distinct modulator segment. In some embodiments, the electrical signals representing the digital input data or the kernel weights have PAMx encoding.

Some aspects of the present disclosure relate to an electronic-photonic integrated circuit (EPIC) device that includes an electrical integrated circuit (EIC) die, a photonic integrated circuit (PIC) die, and an optical source. The EIC die is configured to generate electrical input signals and receive electrical output signals. The PIC die includes optical modulators, an optical core, and an optoelectronic output module. The optical modulators are configured to generate optical input signals from portions of the light based on the electrical input signals. The optical core is configured to perform kernel-based operations on the optical input signals to generate optical output signals. The optoelectronic output module includes optoelectronic transducers and is configured to convert a single optical output signal into at least three distinct electrical output signals. In some embodiments, the one of the optical modulators is configured to transduce a plurality of the electrical input signals into a single optical input signal.

In some embodiments, the optoelectronic output module includes an attenuator configured to attenuate a portion of the single optical output signal to produce a modified optical output signal which is transmitted to one of the optoelectronic transducers. In some embodiments, the attenuator comprises a microring resonator (MRR). In some embodiments, the attenuator comprises a Mach-Zehnder interferometer (MZI).

In some embodiments, the electrical integrated circuit die further comprises a plurality of comparators, each corresponding to one of the three distinct electrical output signals and configured to use a common reference voltage. In some embodiments, the optoelectronic output module is configured to derive at least three modified optical output signals from the single optical output signal, each of the three modified optical output signals having a distinct degree of attenuation and corresponding to a respective one of the three distinct electrical output signals. In some embodiments, the optoelectronic output module is configured to route or distribute the single optical output signal among at least three distinct optical paths, each optical path terminating at a distinct optoelectronic transducer, wherein each optoelectronic transducer is configured to convert a received optical signal into one of the distinct electrical output signals.

Some aspects of the present disclosure relate to an electronic-photonic integrated circuit (EPIC) device that includes an electrical integrated circuit (EIC) die, a photonic integrated circuit (PIC) die, and an optical source. The EIC die is configured to generate electrical input signals and receive electrical output signals. The PIC die includes optical modulators, an optical core, and a splitter. The optical modulators are configured to generate optical input signals from portions of the light based on the electrical input signals. The splitter is configured to divide one of the optical output signals across at least three distinct optical paths, each optical path terminating at a distinct optoelectronic transducer, wherein each optoelectronic transducer is configured to convert the received optical signal into a distinct electrical output signal.

In some embodiments, the EIC die further comprises a plurality of transimpedance amplifiers, each corresponding to one of the electrical output signals, and each configured to apply a same degree of amplification. In some embodiments, each of the distinct optical paths is configured to apply a distinct degree of attenuation to a respective portion of the optical output signal, thereby generating respective modified optical output signals, which are provided to the corresponding optoelectronic transducers. In some embodiments, the distinct degrees of attenuation are configured such that a second modified optical output signal has 50% an amplitude of a first modified optical output signal, and a third modified optical output signal has one third the amplitude of the first modified optical output signal.

In some embodiments, variable optical attenuators are positioned along each of the distinct optical paths, wherein the variable optical attenuators are electronically controlled to provide variable degrees of attenuation. In some embodiments, a control system is configured to adjust electrical control voltages applied to the variable optical attenuators based on the electrical output signals.

Some aspects of the present disclosure relate to a method that includes generating electrical signals representing digital input data and kernel weights and transmitting the electrical input signals to a PIC. The method further includes modulating light based on the electrical signals, thereby generating optical input signals, and using an optical core to perform a kernel-based operation on a first portion of the optical input signals representing the input data using a second portion of the optical input signals to represent the kernel weights, and thereby generating optical output signals. The optical output signals are divided into a plurality of optical signal splits. A distinct degree of attenuation is applied to each optical signal split to generate transformed optical signals. The transformed optical signals are processed to generate corresponding electrical output signals. The electrical output signals are compared to one or more references to produce digital data.

In some embodiments performing the comparisons comprises comparing each of the electrical output signals against a single reference voltage. In some embodiments, the method further includes using a comparison among the electrical output signals to adjust the distinct degrees of attenuation. In some embodiments dividing one of the optical output signals into a plurality of optical signal splits comprises generating the optical signal splits across successive time intervals. In some embodiments dividing one of the optical output signals into a plurality of optical signal splits comprises dividing the optical signal among a plurality of respective optical paths. In some embodiments, the distinct degrees of attenuation are achieved by applying varying amounts of splitting.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic integrated circuit (PIC) device, comprising:
a plurality of optical modulators, each configured to transduce electrical input signals to produce optical input signals, wherein one of the optical modulators comprises two or more modulator segments controlled by distinct electrical input signals, such that the corresponding optical input signal is determined based on a combination of the distinct electrical input signals;
an optical core configured to perform kernel-based operations on the optical input signals to generate optical output signals, wherein a first subset of the optical input signals corresponds to input data for the kernel-based operations, and a second subset of the optical input signals corresponds to kernel weights for the kernel-based operations; and
an optoelectronic output module comprising optoelectronic transducers and configured to convert the optical output signals into electrical output signals.

2. The photonic integrated circuit (PIC) device of claim 1, wherein the two or more modulator segments comprise a first modulator segment and a second modulator segment spaced apart along a waveguide, and the first modulator segment and the second modulator segment have distinct modulation efficiencies.

3. The photonic integrated circuit (PIC) device of claim 2, wherein the second modulator segment has a modulation efficiency at least two times that of the first modulator segment.

4. The photonic integrated circuit (PIC) device of claim 2, wherein the second modulator segment has a modulation efficiency at least four times that of the first modulator segment.

5. The photonic integrated circuit (PIC) device of claim 2, wherein the two or more optical modulators comprises a third modulator segment spaced apart along the waveguide from the first modulator segment and the second modulator segment, and the third modulator segment has a distinct modulation efficiency from each of the first modulator segment and the second modulator segment.

6. The photonic integrated circuit (PIC) device of claim 2, wherein the first modulator segment and the second modulator segment are positioned along a single arm of a Mach-Zehnder modulator.

7. The photonic integrated circuit (PIC) device of claim 6, further comprising a third modulator segment and a fourth modulator segment in a second arm of the Mach-Zehnder modulator.

8. The photonic integrated circuit (PIC) device of claim 1, wherein the two or more modulator segments comprise a first modulator segment and a second modulator segment spaced apart along a waveguide, and the first modulator segment and the second modulator segment have distinct lengths.

9. The photonic integrated circuit (PIC) device of claim 8, wherein the second modulator segment is a positive integer power of two times a length of the first modulator segment.

10. The photonic integrated circuit (PIC) device of claim 9, wherein the one of the optical modulators further comprises a third modulator segment, and the third modulator segment is the positive integer power of two times the length of the second modulator segment.

11. The photonic integrated circuit (PIC) device of claim 1, wherein the two or more modulator segments are positioned along a ring-shaped waveguide.

12. The photonic integrated circuit (PIC) device of claim 1, wherein the two or more modulator segments are attenuators.

13. The photonic integrated circuit (PIC) device of claim 1, wherein the two or more modulator segments comprise p-n or p-i-n junctions in a waveguide.

14. The photonic integrated circuit (PIC) device of claim 1, wherein the optoelectronic output module is configured to provide three or more of the electrical output signals from one of the optical output signals.

15. An electronic-photonic integrated circuit (EPIC) device, comprising:
an electrical integrated circuit (EIC) configured to generate electrical input signals and receive electrical output signals;
an optical source configured to provide light; and
a photonic integrated circuit (PIC), comprising:
a plurality of optical modulators, each configured to modulate a portion of the light to produce a corresponding optical input signal, wherein one of the optical modulators comprises two or more modulator segments controlled by distinct electrical input signals, such that the corresponding optical input signal is determined based on a combination of the distinct electrical input signals;
an optical core configured to perform kernel-based operations on the optical input signals to generate optical output signals, wherein a first subset of the optical input signals corresponds to input data for the kernel-based operations, and a second subset of the optical input signals corresponds to kernel weights for the kernel-based operations; and
an optoelectronic output module comprising optoelectronic transducers and configured to convert the optical output signals into the electrical output signals.

16. The electronic-photonic integrated circuit (EPIC) device of claim 15, wherein the electrical integrated circuit comprises a PAMx encoder that provides one of the electrical input signals, where x is a positive integer greater than or equal to 4.

17. The electronic-photonic integrated circuit (EPIC) device of claim 15, wherein the electrical integrated circuit comprises a field programmable gate array that provides the electrical input signals.

18. A method, comprising:
generating electrical signals representing digital input data and kernel weights, wherein each input datum and each kernel weight is encoded across a plurality of the electrical signals;
transmitting the electrical signals representing the digital input data and the kernel weights to a photonic integrated circuit (PIC) via electrical interconnects;
modulating light based on the electrical signals, thereby generating optical input signals; and
using an optical core within the photonic integrated circuit (PIC) to perform a multiply and accumulate (MAC) or other kernel-based operation on a first portion of the optical input signals representing the input data with a second portion of the optical input signals representing the kernel weights, thereby generating optical output signals.

19. The method of claim 18, wherein modulating light based on the electrical signals comprises applying each of the electrical signals to a distinct modulator segment.

20. The method of claim 18, wherein generating the electrical signals representing digital input data and kernel weights comprises PAMx encoding, wherein x is four or greater.
